(19) United States
(12) Patent Application Publication
(10) Pub. No.: US 2026/0358807 A1
(43) Pub. Date: Nov. 12, 2026

(54) MANAGEMENT SYSTEM FOR WORK SITE AND MANAGEMENT METHOD FOR WORK SITE

(71) Applicants: KOMATSU LTD., Tokyo (JP); TOYOTA JIDOSHA KABUSHIKI KAISHA, Aichi-ken (JP)

(72) Inventors: Shota KONISHI, Tokyo (JP); Takashi HIRANAKA, Tokyo (JP); Kosuke AKATSUKA, Toyota-shi, Aichi (JP); Ruriko SAKAGUCHI, Toyota-shi, Aichi (JP); Masahiro HARADA, Toyota-shi, Aichi (JP); Toru NISHITANI, Toyota-shi, Aichi (JP)

(73) Assignees: KOMATSU LTD., Tokyo (JP); TOYOTA JIDOSHA KABUSHIKI KAISHA, Aichi-ken (JP)

(21) Appl. No.: 19/667,609

(22) Filed: May 4, 2026

(30) Foreign Application Priority Data
May 7, 2025 (JP) 2025-077619

(51) Int. Cl. G05D 1/246; G05D 1/622; G05D 1/65; G05D 1/69; G05D 105/20; G05D 107/90; G05D 109/10; G05D 111/10; G05D 111/50

(52) U.S. Cl. CPC G05D 1/246; G05D 1/622; G05D 1/65; G05D 1/69; G05D 2105/20; G05D 2107/90; G05D 2109/10; G05D 2111/10; G05D 2111/52

(57) ABSTRACT

A worksite management system includes a processor. The processor acquires shape data indicating a shape of surroundings of a first unmanned vehicle traveling at a worksite according to a first travel path, and generates edge data indicating an edge of a traveling area where a second unmanned vehicle is able to travel at the worksite, based on the shape data.

### CROSS-REFERENCE TO RELATED APPLICATION

This application is based on and claims priority under 35 USC 119 from Japanese Patent Application No. 2025-077619 filed May 07, 2025. The entirety the above-mentioned patent application is hereby incorporated by reference herein and made a part of this specification.

### BACKGROUND OF THE INVENTION

### 1. Technical Field

The present disclosure relates to a worksite management system and worksite management method.

### 2. Description of the Related Art

JP 2021-174325 A discloses a method of setting a travel course of a transport vehicle that travels in an unmanned manner. In JP 2021-174325 A, a survey vehicle travels along a boundary line of a terrain such as a bank or a cliff. An outline of a traveling area is set based on a traveling path of the survey vehicle. The travel course of the transport vehicle is set based on the outline of the traveling area.

### SUMMARY OF THE INVENTION

When the survey vehicle traveling at a worksite to set an edge (outline) of the traveling area is a manned vehicle, labor cost and safety management cost may be required. In addition, there is a possibility that a difference occurs in the traveling path of the survey vehicle due to a difference between drivers who drive the survey vehicle.

An object of the present disclosure is to set an edge of a traveling area at a worksite.

According to the present disclosure, a worksite management system including a processor is provided. The processor acquires shape data indicating a shape of surroundings of a first unmanned vehicle traveling at a worksite according to a first travel path, and generates edge data indicating an edge of a traveling area where a second unmanned vehicle is able to travel at the worksite, based on the shape data.

According to the present disclosure, the edge of the traveling area at the worksite is set.

### BRIEF DESCRIPTION OF THE DRAWINGS

FIG. 1 is a diagram schematically illustrating a worksite according to an embodiment;

FIG. 2 is a diagram schematically illustrating a management system of the worksite according to the embodiment;

FIG. 3 is a hardware configuration diagram illustrating a control server according to the embodiment;

FIG. 4 is a block diagram illustrating a light vehicle and a dump truck according to the embodiment;

FIG. 5 is a block diagram illustrating the control server according to the embodiment;

FIG. 6 is a diagram for explaining first travel data of the light vehicle according to the embodiment;

FIG. 7 is a diagram for explaining second travel data of the dump truck according to the embodiment;

FIG. 8 is a flowchart illustrating a worksite management method according to the embodiment;

FIG. 9 is a diagram for explaining a method of generating the first travel data of the light vehicle according to the embodiment;

FIG. 10 is a diagram illustrating an example of a display device that displays shape data and image data according to the embodiment;

FIG. 11 is a diagram for explaining a method of generating the second travel data of the dump truck according to the embodiment; and

FIG. 12 is a diagram for explaining a method of generating the second travel data according to the embodiment.

### DETAILED DESCRIPTION

Hereinafter, embodiments according to the present disclosure will be described with reference to the drawings, but the present disclosure is not limited to the embodiments. Components of the embodiments described below can be appropriately combined. In addition, some components may not be used.

### Worksite

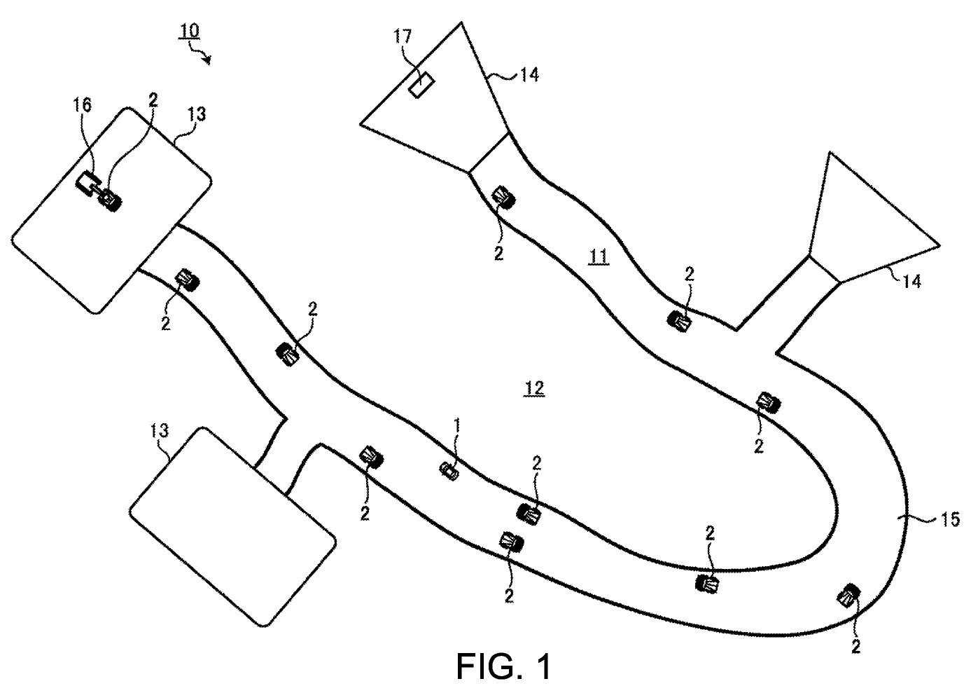

FIG. 1 is a diagram schematically illustrating a worksite 10 according to an embodiment. As the worksite 10, a mine or a quarry is exemplified. The mine refers to a place or a business site where minerals are mined. The quarry refers to a place or business site where stones are mined. As the mine, a metal mine where metal is mined, a non-metal mine where limestone is mined, and a coal mine where coal is mined are exemplified.

In the worksite 10, a first unmanned vehicle 1 and a second unmanned vehicle 2 operate. The unmanned vehicle refers to a vehicle that operates in an unmanned manner without depending on a driving operation by a driver.

In the embodiment, the first unmanned vehicle 1 is a lightweight vehicle that travels at the worksite 10 in an unmanned manner. The first unmanned vehicle 1 may be used to patrol the worksite 10 or transfer workers. In the embodiment, the first unmanned vehicle 1 is appropriately referred to as a light vehicle 1.

In the embodiment, the second unmanned vehicle 2 is a heavy vehicle that travels in the worksite 10 in an unmanned manner. The second unmanned vehicle 2 is a transport vehicle that performs a transport operation of transporting a cargo. In the embodiment, the second unmanned vehicle 2 is appropriately referred to as a dump truck 2.

An outer shape of the light vehicle 1 is smaller than an outer shape of the dump truck 2. A weight of the light vehicle 1 is lighter than a weight of the dump truck 2.

A traveling area 11 and a prohibited area 12 are set at the worksite 10. The traveling area 11 is an area where the light vehicle 1 and the dump truck 2 are permitted to travel. The prohibited area 12 is an area where traveling of the light vehicle 1 and the dump truck 2 is prohibited. The light vehicle 1 and the dump truck 2 can travel in the traveling area 11. The light vehicle 1 and the dump truck 2 cannot travel in the prohibited area 12. In the embodiment, the light vehicle 1 travels at the worksite 10 to set an edge of the traveling area 11.

The traveling area 11 includes a loading area 13, a soil dumping area 14, and a travel path 15. The light vehicle 1 can travel in each of the loading area 13, the soil dumping area 14, and the travel path 15. The dump truck 2 can travel in each of the loading area 13, the soil dumping area 14, and the travel path 15.

The loading area 13 is an area where loading work of loading a cargo onto the dump truck 2 is performed. As the cargo, an excavated object excavated in the loading area 13 is exemplified. An excavator 16 operates in the loading area 13. The excavator 16 performs excavation work and loading work in the loading area 13.

The soil dumping area 14 is an area where soil dumping work for dumping a cargo by the dump truck 2 is performed. A crusher 17 may be provided in the soil dumping area 14.

The travel path 15 refers to an area where the light vehicle 1 and the dump truck 2 travel. The travel path 15 leads to each of the loading area 13 and the soil dumping area 14. The travel path 15 included so as to connect at least the loading area 13 and the soil dumping area 14. The dump truck 2 heading for at least one of the loading area 13 or the soil dumping area 14 travels on the travel path 15. For example, the dump truck 2 travels on the travel path 15 so as to reciprocate between the loading area 13 and the soil dumping area 14.

### Management System

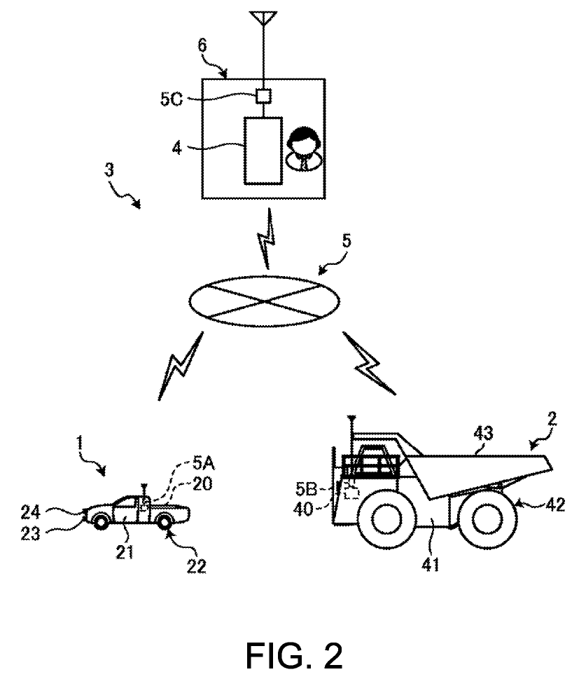

FIG. 2 is a diagram schematically illustrating a management system 3 for the worksite 10 according to the embodiment. The management system 3 manages the worksite 10. The management system 3 manages the light vehicle 1 and the dump truck 2.

The management system 3 includes a control server 4 and a communication system 5. The control server 4 includes a computer. The control server 4 is disposed outside of light vehicle 1 and the dump truck 2. The control server 4 is installed in a control facility 6 at the worksite 10. The communication system 5 includes at least one of the Internet, a mobile phone communication network, a satellite communication network, and a local area network (LAN).

The light vehicle 1 includes a controller 20 and a wireless communication device 5A. The controller 20 includes a computer. The wireless communication device 5A is connected to the controller 20.

The dump truck 2 includes a controller 40 and a wireless communication device 5B. The controller 40 includes a computer. The wireless communication device 5A is connected to the controller 40.

The communication system 5 includes the wireless communication device 5A of the light vehicle 1, the wireless communication device 5B of the dump truck 2, and a wireless communication device 5C connected to the control server 4. The control server 4 and the controller 20 of the light vehicle 1 wirelessly communicate with each other via the communication system 5. The control server 4 and the controller 40 of the dump truck 2 wirelessly communicate with each other via the communication system 5.

### Light Vehicle

The light vehicle 1 includes a vehicle body 21 and a traveling device 22. The vehicle body 21 includes a vehicle body frame. The vehicle body 21 is supported by the traveling device 22. The traveling device 22 travels in the worksite 10 while supporting the vehicle body 21. The traveling device 22 includes wheels and tires mounted on the wheels. The traveling device 22 is operated by power generated by an engine (not illustrated). The traveling device 22 brakes by an operation of a brake device (not illustrated). The traveling device 22 is turned by a steering device (not illustrated).

### Dump Truck

The dump truck 2 includes a vehicle body 41, a traveling device 42, and a dump body 43. The vehicle body 41 includes a vehicle body frame. The vehicle body 41 is supported by the traveling device 42. The traveling device 42 travels in the worksite 10 while supporting the vehicle body 41. The traveling device 42 includes wheels and tires mounted on the wheels. The traveling device 42 is operated by power generated by an engine (not illustrated). The traveling device 42 brakes by an operation of a brake device (not illustrated). The traveling device 42 is turned by a steering device (not illustrated).

The dump body 43 is a member on which a cargo is loaded. The dump body 43 is supported by the vehicle body 41. The dump body 43 performs a dump operation and a lowering operation. The dump operation refers to an operation of separating the dump body 43 from the vehicle body 41 and inclining the dump body 43 in a dump direction. The lowering operation refers to an operation of bringing the dump body 43 close to the vehicle body 41. In a case where the earth removal work is performed, the dump body 43 performs a dump operation. When the dump body 43 performs the dump operation, the cargo of the dump body 43 is discharged from the dump body 43.

### Control Server and Controller

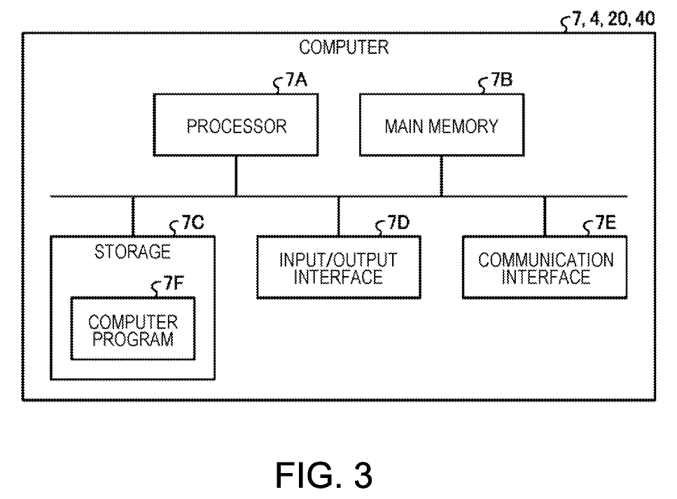

FIG. 3 is a hardware configuration diagram illustrating the control server 4 according to the embodiment. The control server 4 includes a computer 7. The control server 4 includes a processor 7A such as a central processing unit (CPU), a main memory 7B including a volatile memory such as a random access memory (RAM), a storage 7C including a non-volatile memory such as a read only memory (ROM), an input/output interface 7D including an input/output circuit, and a communication interface 7E including a communication circuit. A function of the control server 4 is stored in a storage 7C as a computer program 7F. The processor 7A reads the computer program 7F from the storage 7C, deploys the computer program 7F into the main memory 7B, and executes processing according to the computer program 7F. Note that the computer program 7F may be distributed to the controller 40 via a network.

Similarly to the control server 4, each of the controller 20 of the light vehicle 1 and the controller 40 of the dump truck 2 includes the computer 7. Each of the controller 20 of the light vehicle 1 and the controller 40 of the dump truck 2 also includes a processor 7A, a main memory 7B, a storage 7C that stores a computer program 7F, an input/output interface 7D, and a communication interface 7E.

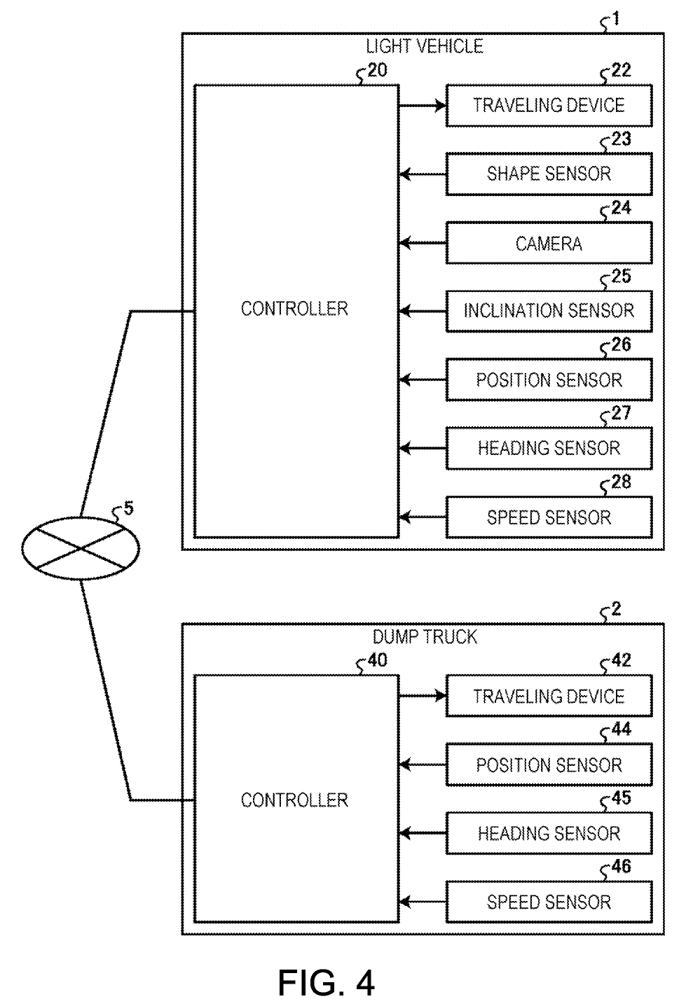

FIG. 4 is a block diagram illustrating the light vehicle 1 and the dump truck 2 according to the embodiment. The light vehicle 1 includes a controller 20, a traveling device 22, a shape sensor 23, a camera 24, an inclination sensor 25, a position sensor 26, a heading sensor 27, and a speed sensor 28.

The shape sensor 23 detects a shape of an object around the light vehicle 1 in a non-contact manner. The shape sensor 23 detects a shape of an object by emitting an energy wave. In the embodiment, the shape sensor 23 is a laser sensor (Li DAR: Light Detection and Ranging) that detects an object by emitting laser light. The shape sensor 23 is a three-dimensional sensor that detects a three-dimensional shape of an object around the light vehicle 1. Note that the shape sensor 23 may be a stereo camera. As illustrated in FIG. 2, the shape sensor 23 is disposed at a front portion of the vehicle body 21. Note that the shape sensor 23 may be disposed at each of the front portion and a rear portion of the vehicle body 21.

The camera 24 images an object around the light vehicle 1. The camera 24 acquires an images of an object around the light vehicle 1. In the embodiment, the camera 24 is an RGB camera. Note that the camera 24 may be an RGB-D camera or a hyperspectral camera. As illustrated in FIG. 2, the camera 24 is disposed at a front portion of the vehicle body 21. Note that the camera 24 may be disposed at each of the front portion and a rear portion of the vehicle body 21.

At least a part of a detection area of the shape sensor 23 overlaps with at least a part of an imaging area of the camera 24. The shape sensor 23 detects an object present in the detection area. The camera 24 images an object present in the imaging area.

The inclination sensor 25 detects an inclination angle of the light vehicle 1 with respect to a horizontal plane. The inclination sensor 25 is disposed on the vehicle body 21. The light vehicle 1 travels on a road surface of the traveling area 11. By detecting the inclination angle of the light vehicle 1 with respect to the horizontal plane, the inclination angle of the road surface with respect to the horizontal plane is detected. An inertial measurement unit (IMU) is exemplified as the inclination sensor 25.

The position sensor 26 detects a position of the light vehicle 1. The position sensor 26 is disposed on the vehicle body 21. The position sensor 26 detects the position of the light vehicle 1 using a global navigation satellite system (GNSS). The global navigation satellite system includes a global positioning system (GPS). The global navigation satellite system detects a position in a global coordinate system defined by coordinate data of latitude, longitude, and altitude. The global coordinate system refers to a coordinate system fixed to the earth. The position sensor 26 includes a GNSS receiver disposed on the vehicle body 21. The position sensor 26 detects the position of the light vehicle 1 in the global coordinate system.

The heading sensor 27 detects the heading of the light vehicle 1. The heading sensor 27 is disposed on the vehicle body 21. The heading of the light vehicle 1 includes a heading angle with respect to a reference heading. The reference heading is, for example, north. As the heading sensor 27, an inertial measurement unit (IMU) is exemplified. Note that the heading sensor 27 may include an arithmetic unit that calculates a heading from position data detected by two GNSS antennas provided in the light vehicle 1. The arithmetic unit can calculate the heading from a vector connecting the two GNSS antennas.

The speed sensor 28 detects a traveling speed of the light vehicle 1. The speed sensor 28 detects, for example, a rotation speed of a drive shaft connected to a wheel of the traveling device 22 to detect the traveling speed of the light vehicle 1.

The dump truck 2 includes the controller 40, the traveling device 42, a position sensor 44, a heading sensor 45, and a speed sensor 46.

The position sensor 44 detects the position of the dump truck 2. The position sensor 44 is disposed on the vehicle body 41. The position sensor 44 detects the position of the dump truck 2 using a global navigation satellite system (GNSS). The position sensor 44 includes a GNSS receiver disposed on the vehicle body 41. The position sensor 44 detects the position of the dump truck 2 in the global coordinate system.

The heading sensor 45 detects the heading of the dump truck 2. The heading sensor 45 is disposed on the vehicle body 41. As the heading sensor 45, an inertial measurement unit (IMU) is exemplified. Note that the heading sensor 45 may include an arithmetic unit that calculates the heading from the position data detected by two GNSS antennas provided in the dump truck 2.

The speed sensor 46 detects a traveling speed of the dump truck 2. The speed sensor 46 detects, for example, a rotation speed of a drive shaft connected to a wheel of the traveling device 42, to detect the traveling speed of the dump truck 2.

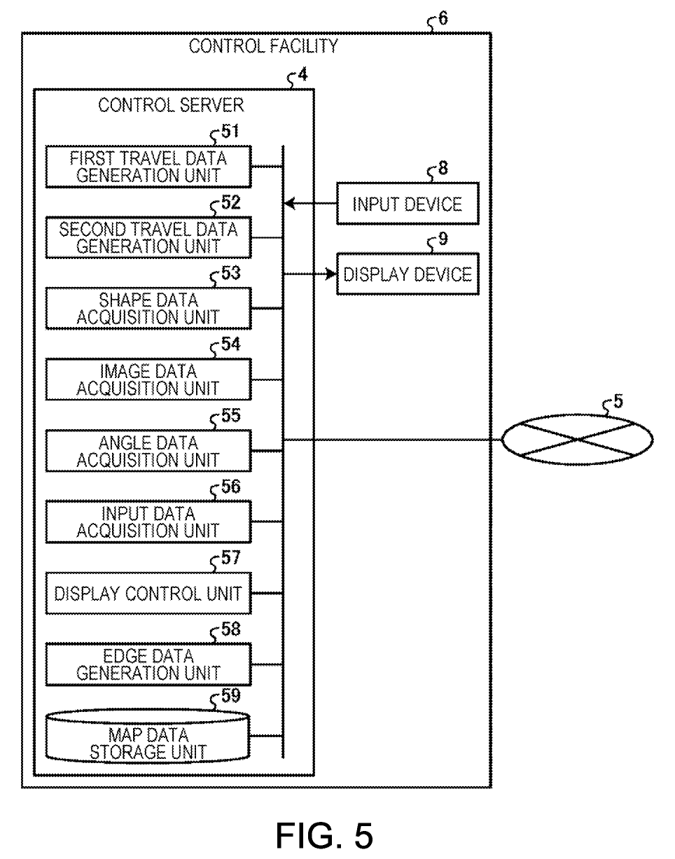

FIG. 5 is a block diagram illustrating the control server 4 according to the embodiment. The control server 4 is connected to the input device 8 and the display device 9. Each of the input device 8 and the display device 9 is arranged in the control facility 6. The input device 8 is operated by an administrator existing in the control facility 6. The input device 8 is operated by the administrator to generate input data. The input data generated in the input device 8 is input into the control server 4. Examples of the input device 8 include a touch panel, a computer keyboard, and an input button. The display device 9 provides the display data to the administrator existing in the control facility 6. As the display device 9, a flat panel display such as a liquid crystal display or an organic EL display is exemplified.

The control server 4 has a plurality of functional units. The functional units of the control server 4 include a first travel data generation unit 51, a second travel data generation unit 52, a shape data acquisition unit 53, an image data acquisition unit 54, an angle data acquisition unit 55, an input data acquisition unit 56, a display control unit 57, an edge data generation unit 58, and a map data storage unit 59. The function of each of the first travel data generation unit 51, the second travel data generation unit 52, the shape data acquisition unit 53, the image data acquisition unit 54, the angle data acquisition unit 55, the input data acquisition unit 56, the display control unit 57, and the edge data generation unit 58 is exerted by the processor 7A of the control server 4. The function of the map data storage unit 59 is exerted by the storage 7C of the control server 4.

The first travel data generation unit 51 generates first travel data indicating a travel condition of the light vehicle 1. The first travel data generation unit 51 transmits the generated first travel data to the controller 20 of the light vehicle 1.

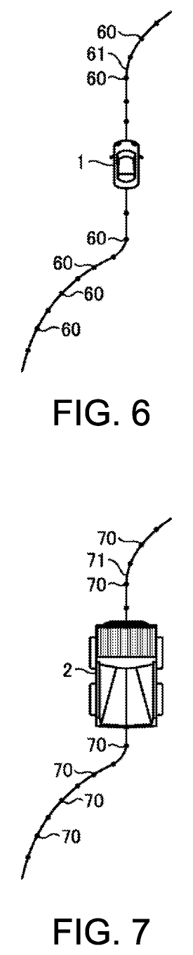

FIG. 6 is a diagram for explaining the first travel data of the light vehicle 1 according to the embodiment. The first travel data defines the travel condition of the light vehicle 1. The travel data of the light vehicle 1 includes a traveling point 60, a first travel path 61, a target position of the light vehicle 1, a target heading of the light vehicle 1, and a target traveling speed of the light vehicle 1.

A plurality of traveling points 60 are set in the traveling area 11 of the worksite 10. The traveling point 60 defines the target position of the light vehicle 1. The target heading of the light vehicle 1 and the target traveling speed of the light vehicle 1 are set for each of the plurality of traveling points 60. The plurality of traveling points 60 are set at intervals. The intervals between the traveling points 60 may be uniform or non-uniform.

The target position of the light vehicle 1 refers to a target position of the light vehicle 1 when the light vehicle 1 passes through the traveling point 60. The target position of the light vehicle 1 may be defined in a local coordinate system of the light vehicle 1 or may be defined in a global coordinate system. The target heading of the light vehicle 1 refers to a target heading of the light vehicle 1 when the light vehicle 1 passes through the traveling point 60. The target traveling speed of the light vehicle 1 refers to a target traveling speed of the light vehicle 1 when the light vehicle 1 passes through the traveling point 60.

The first travel path 61 is a virtual line indicating a target travel route of the light vehicle 1. The first travel path 61 is defined by a trajectory passing through a plurality of traveling points 60. The light vehicle 1 travels in the traveling area 11 of the worksite 10 according to the first travel path 61. The light vehicle 1 travels such that the center of the light vehicle 1 coincides with the first travel path 61 in the vehicle width direction of the light vehicle 1.

The controller 20 of the light vehicle 1 controls the traveling device 22 such that the light vehicle 1 travels along the first travel path 61, based on the detection data of the position sensor 26 and the detection data of the heading sensor 27. That is, the controller 20 controls the traveling device 22 so as to reduce a deviation between the detected position of the light vehicle 1 detected by the position sensor 26 when passing through the traveling point 60 and the target position of the light vehicle 1 set for the traveling point 60. The controller 20 controls the traveling device 22 so as to reduce a deviation between the detected heading of the light vehicle 1 detected by the heading sensor 27 when passing through the traveling point 60 and the target heading of the light vehicle 1 set for the traveling point 60. The controller 20 controls the traveling device 22 such that the light vehicle 1 travels at the target traveling speed, based on the detection data of the speed sensor 28. That is, the controller 20 controls the traveling device 22 so as to reduce a deviation between the detected traveling speed of the light vehicle 1 detected by the speed sensor 28 when passing through the traveling point 60 and the target traveling speed of the light vehicle 1 set for the traveling point 60.

The second travel data generation unit 52 generates second travel data indicating a travel condition of the dump truck 2. The second travel data generation unit 52 transmits the generated second travel data to the controller 40 of the dump truck 2.

FIG. 7 is a diagram for explaining the second travel data of the dump truck 2 according to the embodiment. The second travel data defines a travel condition of the dump truck 2. The travel data of the dump truck 2 includes a traveling point 70, a second travel path 71, a target position of the dump truck 2, a target heading of the dump truck 2, and a target traveling speed of the dump truck 2.

The traveling point 70 of the second travel data has the same function as the traveling point 60 of the first travel data. The second travel path 71 of the second travel data has the same function as the first travel path 61 of the first travel data. The second travel path 71 refers to a virtual line indicating a target travel route of the dump truck 2. The second travel path 71 is defined by a trajectory passing through a plurality of traveling points 70. The dump truck 2 travels such that the center of the dump truck 2 coincides with the second travel path 71 in the vehicle width direction of the dump truck 2.

The controller 40 of the dump truck 2 controls the traveling device 42 such that the dump truck 2 travels along the second travel path 71, based on the detection data of the position sensor 44 and the detection data of the heading sensor 45. The controller 40 controls the traveling device 42 such that the dump truck 2 travels at a target traveling speed, based on the detection data of the speed sensor 28.

The shape data acquisition unit 53 acquires shape data indicating a shape of the surroundings of the light vehicle 1 traveling at the worksite 10 according to the first travel path 61. The controller 20 transmits the detection data of the shape sensor 23 to the control server 4. The shape data acquisition unit 53 acquires shape data indicating a shape of the surroundings of the light vehicle 1 detected by the shape sensor 23 when the light vehicle 1 is traveling along the first travel path 61.

The image data acquisition unit 54 acquires image data indicating an image of the surroundings of the light vehicle 1 traveling at the worksite 10 according to the first travel path 61. The controller 20 transmits image data captured by the camera 24 to the control server 4. The image data acquisition unit 54 acquires image data indicating an image of the surroundings of the light vehicle 1 captured by the camera 24 when the light vehicle 1 is traveling along the first travel path 61.

The angle data acquisition unit 55 acquires angle data indicating an inclination angle of the light vehicle 1 traveling at the worksite 10 according to the first travel path 61. The controller 20 transmits the detection data of the inclination sensor 25 to the control server 4. The angle data acquisition unit 55 acquires angle data indicating the inclination angle of the light vehicle 1 detected by the inclination sensor 25 when the light vehicle 1 is traveling along the first travel path 61.

The input data acquisition unit 56 acquires input data from the input device 8.

The display control unit 57 causes the display device 9 to display the shape data acquired by the shape data acquisition unit 53. The display control unit 57 causes the display device 9 to display the image data acquired by the image data acquisition unit 54.

The edge data generation unit 58 generates edge data indicating an edge of the traveling area 11 where the light vehicle 1 and the dump truck 2 can travel at the worksite 10, based on the shape data acquired by the shape data acquisition unit 53. As described later, the edge of the traveling area 11 includes an edge line 81 along the edge of the traveling area 11.

In the embodiment, the edge data generation unit 58 generates edge data based on the shape data acquired by the shape data acquisition unit 53 and the input data acquired by the input data acquisition unit 56. As described above, the shape data and the image data are displayed on the display device 9. The administrator operates the input device 8 to designate an edge while referring to the shape data and the image data displayed on the display device 9. The edge data generation unit 58 generates edge data based on the input data.

The map data storage unit 59 stores map data indicating a map of the worksite 10 including the traveling area 11. The map of the worksite 10 includes a boundary line between the traveling area 11 and the prohibited area 12.

### Management Method

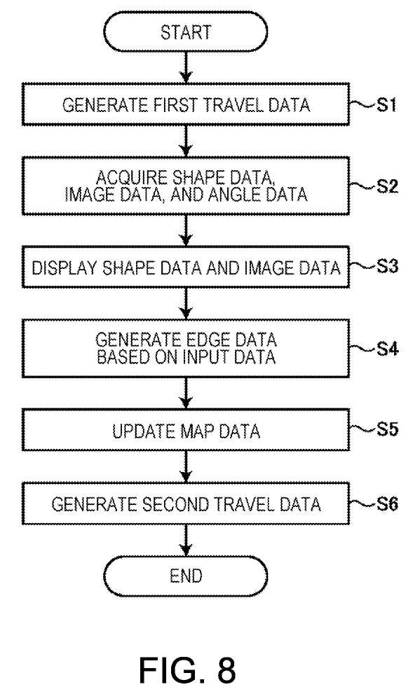

FIG. 8 is a flowchart illustrating a worksite management method 10 according to the embodiment. The first travel data generation unit 51 generates first travel data of the light vehicle 1 including the first travel path 61 (step S1).

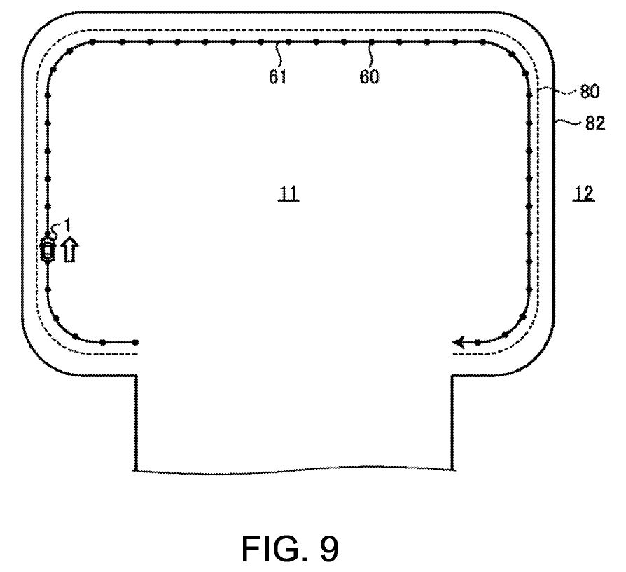

FIG. 9 is a diagram for explaining a method of generating the first travel data of the light vehicle 1 according to the embodiment. In the embodiment, the first travel data generation unit 51 generates the first travel data based on the map data of the worksite 10 stored in the map data storage unit 59. The map data of the worksite 10 includes a three-dimensional shape of the worksite 10. The map data of the worksite 10 is defined in the global coordinate system.

The map data of the worksite 10 includes a reference line 80 defined at an outer edge portion of the traveling area 11. The position of the reference line 80 is defined in the global coordinate system. The first travel data generation unit 51 generates the first travel data based on the position of the reference line 80 defined in the map data. The first travel data generation unit 51 generates the first travel path 61 at a position offset by a specified amount from the reference line 80 toward the central portion of the traveling area 11.

The terrain of the worksite 10 changes, for example, with the progress of excavation work or ground leveling work. In the embodiment, the map data stored in the map data storage unit 59 is updated in accordance with the change in the terrain of the worksite 10. The reference line 80 is updated by the edge data generation unit 58. As described later, the edge data generation unit 58 generates the edge line 81 as edge data. The reference line 80 is updated to the latest edge line 81. The reference line 80 corresponds to the edge line 81 before being updated to the latest edge line 81. That is, the reference line 80 corresponds to the edge line 81 of the previous generation. The first travel data generation unit 51 generates the first travel path 61 based on the reference line 80 that is the edge line 81 of the previous generation.

Note that in FIG. 9, a boundary line 82 existing outside the reference line 80 indicates a boundary between the traveling area 11 and the prohibited area 12. The boundary line 82 is defined by a characteristic portion of the worksite 10 such as a bank or a cliff. The characteristic portion partitions the traveling area 11 and the prohibited area 12. For example, when the terrain of the worksite 10 changes with the progress of excavation work, the position of the boundary line 82 changes.

After the first travel data is generated, the light vehicle 1 travels according to the first travel path 61. The shape sensor 23 detects a shape of the surroundings of the light vehicle 1 while the light vehicle 1 is traveling along the first travel path 61. The camera 24 images the surroundings of the light vehicle 1 while the light vehicle 1 is traveling along the first travel path 61. The inclination sensor 25 detects the inclination angle of the light vehicle 1 while the light vehicle 1 is traveling along the first travel path 61. The controller 20 transmits, to the control server 4, shape data indicating a shape of the surroundings of the light vehicle 1 detected by the shape sensor 23. The controller 20 transmits, to the control server 4, image data of the surroundings of the light vehicle 1 captured by the camera 24. The controller 20 transmits, to the control server 4, angle data indicating the inclination angle of the light vehicle 1 detected by the inclination sensor 25.

The shape data acquisition unit 53 acquires shape data indicating a shape of the surroundings of the light vehicle 1 traveling in the traveling area 11 according to the first travel path 61. The image data acquisition unit 54 acquires image data indicating an image of the surroundings of the light vehicle 1 traveling in the traveling area 11 according to the first travel path 61. The angle data acquisition unit 55 acquires angle data indicating an inclination angle of the light vehicle 1 traveling in the traveling area 11 according to the first travel path 61 (step S2).

The display control unit 57 causes the display device 9 to display the shape data acquired by the shape data acquisition unit 53 and the image data acquired by the image data acquisition unit 54 (step S3).

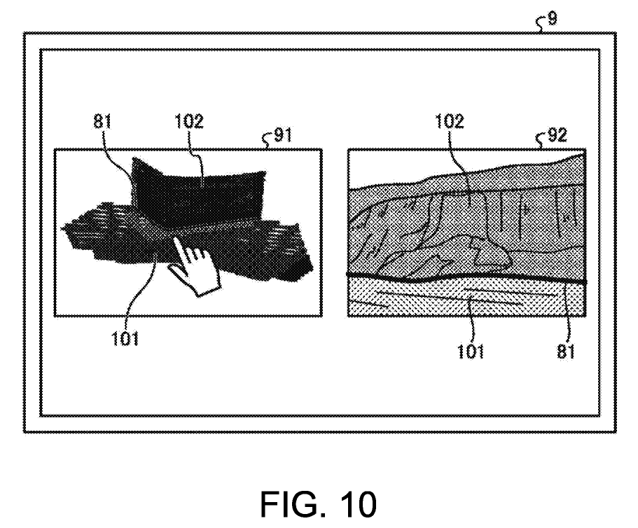

FIG. 10 is a diagram illustrating an example of a display device that displays the shape data and the image data according to the embodiment. In the embodiment, the shape data indicates a three-dimensional shape of a terrain around the light vehicle 1. As illustrated in FIG. 10, the display control unit 57 causes the display device 9 to display, as the shape data, three-dimensional point cloud data 91 indicating the three-dimensional shape of the terrain around the light vehicle 1. The display control unit 57 causes the display device 9 to display the image data 92 of the terrain around the light vehicle 1. The three-dimensional point cloud data 91 and the image data 92 are displayed in parallel on the display device 9.

The detection area of the shape sensor 23 and at least a part of the imaging area of the camera 24 overlap. The object detected by the shape sensor 23 and at least a part of the object imaged by the camera 24 are the same. The portion of the terrain detected by the shape sensor 23 and at least a part of the portion of the terrain imaged by the camera 24 are the same. The three-dimensional point cloud data 91 indicating a predetermined part around the light vehicle 1 and the image data 92 indicating the predetermined part are displayed on the display device 9.

In the embodiment, the edge of the traveling area 11 is designated by the administrator. The administrator operates the input device 8 to designate an edge while confirming the three-dimensional point cloud data 91 and the image data 92 displayed on the display device 9. The edge is designated in a line along the longitudinal direction of the edge. In the following description, the edge designated in a line shape is appropriately referred to as the edge line 81. The position of the edge line 81 is defined in the global coordinate system.

The administrator operates the input device 8 to designate the edge line 81. In a case where the input device 8 is a touch sensor provided on the display screen of the display device 9, that is, in a case where the display device 9 includes a touch panel, the administrator can designate the edge line 81 by tracing the display screen of the display device 9 with a finger. When a road surface 101 on which the light vehicle 1 and the dump truck 2 can travel and a bank 102 provided in the vicinity of the road surface 101 exist at the worksite 10, the administrator may designate the edge line 81 along the longitudinal direction of the boundary between the road surface 101 and the bank 102.

The three-dimensional point cloud data 91 and the image data 92 are associated with each other. XYZ coordinates of the three-dimensional point cloud data 91 are converted into pixel values of the image data 92 by a coordinate transformation matrix. For example, in a case where the edge line 81 is designated in the three-dimensional point cloud data 91, the edge line 81 is automatically designated in the image data 92. When the edge line 81 is designated in the image data 92, the edge line 81 is automatically designated in the three-dimensional point cloud data 91.

The edge data generation unit 58 generates edge data based on the input data from the input device 8. The edge data generation unit 58 generates, as the edge data, the edge line 81 designated by the administrator (step S4).

The edge data generation unit 58 stores the edge data generated in step S4 in the map data storage unit 59. The edge data generation unit 58 updates the position of the reference line 80 stored in the map data storage unit 59 based on the edge data generated in step S4. The edge data includes the position of the edge line 81. The reference line 80 stored in the map data storage unit 59 is updated to the edge line 81 acquired in step S4 (step S5).

The second travel data generation unit 52 generates second travel data indicating the travel condition of the dump truck 2 including the second travel path 71, based on the edge data generated in step S4 (step S6).

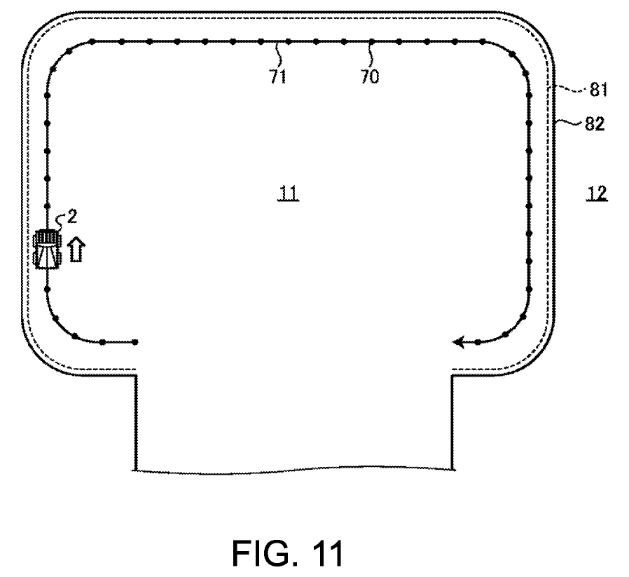

FIG. 11 is a diagram for explaining a method of generating the second travel data of the dump truck 2 according to the embodiment. The second travel data generation unit 52 generates the second travel data based on the position of the edge line 81. The second travel data generation unit 52 generates the second travel path 71 at a position offset by a specified amount from the edge line 81 toward the central portion of the traveling area 11. After the second travel data is generated, the dump truck 2 travels along the second travel path 71.

### Method of Generating Second Travel Data

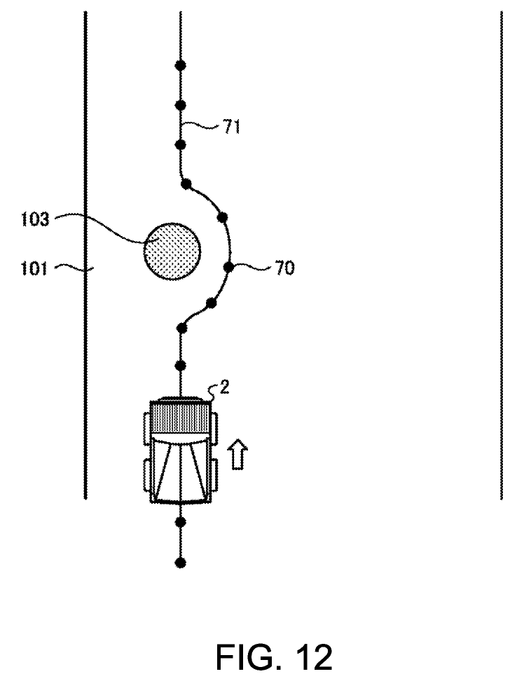

FIG. 12 is a diagram for explaining a method of generating the second travel data according to the embodiment. As described above, the shape sensor 23 of the light vehicle 1 detects the shape of the surroundings of the light vehicle 1. The shape sensor 23 can detect the shape of the road surface 101 in the traveling area 11.

The shape sensor 23 can detect an abnormal shape 103 that hinders traveling of the dump truck 2 on the road surface 101 of the traveling area 11. The shape data acquired in step S2 described above includes the abnormal shape 103 that hinders traveling of the dump truck 2. The abnormal shape 103 that hinders traveling of the dump truck 2 includes a protrusion or a recess formed on the road surface 101 of the traveling area 11. The protrusion includes an obstacle existing on the road surface 101. The recess includes a hole existing in the road surface 101. As illustrated in FIG. 12, the second travel data generation unit 52 can generate the second travel data such that the second travel path 71 avoids the portion of the abnormal shape 103.

As described above, the second travel data includes the target traveling speed of the dump truck 2. The second travel data generation unit 52 can set the target traveling speed of the dump truck 2 based on the shape data acquired in step S2 described above. The second travel data generation unit 52 can generate the second travel data such that the target traveling speed of the dump truck 2 decreases in the portion of the abnormal shape 103.

In step S2 described above, the angle data acquisition unit 55 acquires angle data indicating the inclination angle of the light vehicle 1 with respect to the horizontal plane. By detecting the inclination angle of the light vehicle 1 with respect to the horizontal plane, the inclination angle of the road surface 101 with respect to the horizontal plane is detected. The second travel data generation unit 52 can set the target traveling speed of the dump truck 2 based on the angle data. In a case where the inclination angle of the road surface 101 is less than a predetermined angle threshold, the second travel data generation unit 52 sets the target traveling speed of the dump truck 2 to a first target speed. In a case where the inclination angle of the road surface 101 is equal to or larger than the predetermined angle threshold, the second travel data generation unit 52 sets the target traveling speed of the dump truck 2 to a second target speed lower than the first target speed. That is, in a case where the road surface 101 is steep, the second travel data generation unit 52 sets the target traveling speed of the dump truck 2 to a low value.

In addition, in a case where the inclination angle of the road surface 101 is less than the predetermined angle threshold, the first travel data generation unit 51 sets the target traveling speed of the light vehicle 1 to a third target speed. In a case where the inclination angle of the road surface 101 is equal to or larger than the predetermined angle threshold, the first travel data generation unit 51 sets the target traveling speed of the light vehicle 1 to a fourth target speed lower than the third target speed. The third target speed may be the same value as the first target speed. The fourth target speed may be the same value as the second target speed. In a case where the inclination angle of the road surface 101 is equal to or larger than the predetermined angle threshold, there is a possibility that the detection data of the shape sensor 23 and the image data captured by the camera 24 are not accurately acquired. In a case where the inclination angle of the road surface 101 is equal to or larger than the predetermined angle threshold, by setting the target traveling speed of the light vehicle 1 to a low value, the controller 20 can accurately acquire the shape data indicating the shape of the surroundings of the light vehicle 1 detected by the shape sensor 23 and the image data of the surroundings of the light vehicle 1 captured by the camera 24.

### Map Data

The map data stored in the map data storage unit 59 may include the shape data of the road surface 101 detected by the shape sensor 23. The map data may include the position of the abnormal shape 103. In a case where the abnormal shape 103 is a protrusion provided on the road surface 101, the map data may include the height of the protrusion. In a case where the abnormal shape 103 is a recess provided on the road surface 101, the map data may include the depth of the recess.

### Transmission of Shape Data and Image Data

As described above, in step S2, the controller 20 transmits, to the control server 4, the shape data indicating the shape of the surroundings of the light vehicle 1 detected by the shape sensor 23. In a case where the inclination angle of the light vehicle 1 detected by the inclination sensor 25 is equal to or larger than the predetermined angle threshold, the controller 20 may not transmit the shape data to the control server 4.

That is, the controller 20 may not transmit, to the control server 4, the shape data detected when the road surface 101 is steep. The shape data detected when the road surface 101 is steep is likely to include an error. Therefore, the controller 20 may not transmit, to the control server 4, the shape data detected when the road surface 101 is steep. Similarly, in a case where the inclination angle of the light vehicle 1 detected by the inclination sensor 25 is equal to or larger than the predetermined angle threshold, the controller 20 may not transmit, to the control server 4, the image data indicating the image of the surroundings of the light vehicle 1 captured by the camera 24.

When causing the light vehicle 1 to travel based on the first travel data, the controller 20 may control traveling of the light vehicle 1 based on the shape data of the road surface 101 detected by the shape sensor 23. The controller 20 may adjust the traveling speed of the light vehicle 1 based on the shape data of the road surface 101. In a case where the abnormal shape 103 of the road surface 101 is detected by the shape sensor 23, the controller 20 may decelerate or stop the light vehicle 1. In a case where the abnormal shape 103 of the road surface 101 is detected, the controller 20 may control the traveling device 22 of the light vehicle 1 so as to travel while avoiding the portion of the abnormal shape 103.

In a case where the abnormal shape 103 of the road surface 101 is not detected, the controller 20 may not transmit the shape data of the road surface 101 to the control server 4. In a case where the abnormal shape 103 of the road surface 101 is detected by the shape sensor 23 and the light vehicle 1 is decelerated or stopped, the controller 20 may transmit the shape data of the road surface 101 to the control server 4.

### Effects

As described above, the processor 7A of the control server 4 includes the shape data acquisition unit 53 that acquires shape data indicating the shape of the surroundings of the light vehicle 1 traveling in the worksite 10 according to the first travel path 61, and the edge data generation unit 58 that generates edge data indicating the edge (edge line 81) of the traveling area 11 where the dump truck 2 can travel in the worksite 10 based on the shape data.

According to the embodiment, the light vehicle 1 is used as a survey vehicle that travels in the worksite 10 to set the edge of the traveling area 11. Since the light vehicle 1, which is a survey vehicle, is an unmanned vehicle that travels along the first travel path 61, the edge of the traveling area 11 at the worksite 10 is smoothly set. Since the light vehicle 1 is an unmanned vehicle, labor cost and safety management cost are reduced.

### OTHER EMBODIMENTS

In the above-described embodiment, the edge data generation unit 58 generates the edge data based on the input data from the input device 8 operated by the administrator. The edge data generation unit 58 may generate the edge data based on the shape data without using the input data. The edge data generation unit 58 can distinguish the road surface 101 on which the light vehicle 1 and the dump truck 2 can travel and the characteristic portion existing in the vicinity of the road surface 101, based on the shape data. A bank or a cliff is exemplified as a characteristic portion. The characteristic portion is partitioned from the road surface 101. The edge data generation unit 58 may set a boundary between the road surface 101 and a characteristic portion (bank or cliff) as an edge (edge line 81).

In the above-described embodiment, at least a part of the functional units of the control server 4 may be provided in the controller 20 of the light vehicle 1. At least a part of the functional units of the control server 4 may be provided in the controller 40 of the dump truck 2.

In the above-described embodiment, each of the plurality of functional units of the control server 4 may be configured by a separate computer (hardware). For example, the first travel data generation unit 51 and the second travel data generation unit 52 may be configured by a first computer, and the edge data generation unit 58 may be configured by a second computer.

What is claimed is:

1. A worksite management system comprising:
a processor, wherein
the processor is configured to
acquire shape data indicating a shape of surroundings of a first unmanned vehicle traveling at a worksite according to a first travel path, and
generate edge data indicating an edge of a traveling area where a second unmanned vehicle is able to travel at the worksite, based on the shape data.

2. The worksite management system according to claim 1, wherein
the processor is configured to
cause a display device to display the shape data,
acquire input data from an input device, and
generate the edge data based on the input data.

3. The worksite management system according to claim 2, wherein
the processor is configured to
acquire image data indicating an image of the surroundings of the first unmanned vehicle, and
cause the display device to display the image data.

4. The worksite management system according to claim 1, comprising
a storage, wherein
the storage
stores map data indicating a map of the worksite including a reference line defined in an outer edge portion of the traveling area, and
the processor is configured to
generate first travel data indicating a travel condition of the first unmanned vehicle including the first travel path, based on a position of the reference line.

5. The worksite management system according to claim 4, wherein
the processor is configured to
update the position of the reference line stored in the storage, based on the edge data.

6. The worksite management system according to claim 1, wherein
the processor is configured to
generate second travel data indicating a travel condition of the second unmanned vehicle including a second travel path, based on the edge data.

7. The worksite management system according to claim 6, wherein
the shape data includes an abnormal shape that hinders traveling of the second unmanned vehicle, and
the processor is configured to
generate the second travel data such that the second travel path avoids a portion with the abnormal shape.

8. The worksite management system according to claim 6, wherein
the second travel data includes a target traveling speed of the second unmanned vehicle, and
the processor is configured to
set a target traveling speed of the second unmanned vehicle based on the shape data.

9. The worksite management system according to claim 8, wherein
the shape data includes an abnormal shape that hinders traveling of the second unmanned vehicle, and
the processor is configured to
generate the second travel data such that a target traveling speed of the second unmanned vehicle decreases in a portion with the abnormal shape.

10. The worksite management system according to claim 6, wherein
the processor is configured to
acquire angle data indicating an inclination angle of the first unmanned vehicle, and
set a target traveling speed of the second unmanned vehicle based on the angle data.

11. A worksite management method, comprising:
acquiring shape data indicating a shape of surroundings of a first unmanned vehicle traveling at a worksite according to a first travel path, and
generating edge data indicating an edge of a traveling area where a second unmanned vehicle is able to travel at the worksite, based on the shape data.

12. The worksite management method according to claim 11, comprising:
causing a display device to display the shape data; and
acquiring input data from an input device, wherein
the edge data is generated based on the input data.

13. The worksite management method according to claim 12, comprising
acquiring image data indicating an image of the surroundings of the first unmanned vehicle, wherein
the display device is caused to display the image data.

14. The worksite management method according to claim 11, comprising
storing map data indicating a map of the worksite including a reference line defined in an outer edge portion of traveling area, wherein
first travel data indicating a travel condition of the first unmanned vehicle including the first travel path is generated based on a position of the reference line.

15. The worksite management method according to claim 14, wherein
the position of the reference line is updated based on the edge data.

16. The worksite management method according to claim 11, comprising
generating second travel data indicating a travel condition of the second unmanned vehicle including a second travel path, based on the edge data.

17. The worksite management method according to claim 16, wherein
the shape data includes an abnormal shape that hinders traveling of the second unmanned vehicle, and
the second travel data is generated such that the second travel path avoids a portion with the abnormal shape.

18. The worksite management method according to claim 16, wherein
the second travel data includes a target traveling speed of the second unmanned vehicle, and
a target traveling speed of the second unmanned vehicle is set based on the shape data.

19. The worksite management method according to claim 18, wherein
the shape data includes an abnormal shape that hinders traveling of the second unmanned vehicle, and
the second travel data is generated such that a target traveling speed of the second unmanned vehicle decreases in a portion with the abnormal shape.

20. The worksite management method according to claim 16, comprising
acquiring angle data indicating an inclination angle of the first unmanned vehicle, and
setting a target traveling speed of the second unmanned vehicle based on the angle data.
